(19) United States
(12) Patent Application Publication
(10) Pub. No.: US 2021/0040855 A1
(43) Pub. Date: Feb. 11, 2021

(54) ASSEMBLY OF TURBINE BLADES AND CORRESPONDING ARTICLE OF MANUFACTURE

(71) Applicant: Siemens Aktiengesellschaft, München (DE)

(72) Inventors: Ross Gustafson, Charlotte, NC (US); Li Shing Wong, Oviedo, FL (US); Farzad Taremi, Palm Beach Gardens, FL (US)

(21) Appl. No.: 16/965,659

(22) PCT Filed: Feb. 15, 2018
(86) PCT No.: PCT/US2018/018270

§ 371 Date: Jul. 29, 2020

(51) Int. Cl. F01D 5/14

(52) U.S. Cl. CPC F01D 5/141

(57) ABSTRACT

An assembly of turbine blades or vanes includes a first and a second airfoil extending span-wise from a first and a second platform respectively. The first and the second platform respectively have a first and a second mate face that interface along a platform splitline. The first mate face is proximal to a suction side of the first airfoil the second mate face is proximal to a pressure side of the second airfoil. The first mate face is chamfered or filleted along an aft portion thereof. The chamfered or filleted portion of the first mate face lies in a region in a flow path between the first and second airfoils where a mean velocity of the working medium is directed from the second platform to the first platform.

### BACKGROUND

### 1. Field

The present invention relates to rotating turbine blades or stationary turbine vanes for gas turbine engines, and in particular to platforms of turbine blades or vanes.

### 2. Description of the Related Art

In a turbomachine, such as a gas turbine engine, air is pressurized in a compressor section and then mixed with fuel and burned in a combustor section to generate hot combustion gases. The working medium, comprising hot combustion gases is expanded within a turbine section of the engine where energy is extracted to power the compressor section and to produce useful work, such as turning a generator to produce electricity. The working medium travels through a series of turbine stages within the turbine section. A turbine stage may include a row of stationary vanes, followed by a row of rotating blades, where the blades extract energy from the hot combustion gases for providing output.

A turbine blade or vane unit typically comprises at least one airfoil extending span-wise from a platform. In some cases, for example, in stationary vanes, the airfoil(s) may extend between two platforms, namely an outer diameter platform and an inner diameter platform. Each platform has a pair of mate faces on laterally opposite ends, which extend from a platform leading edge to a platform trailing edge. Each mate face of the platform engages with an opposite mate face of a circumferentially adjacent blade or vane unit, to form an assembly of a row of turbine blades or vanes. The platforms define an endwall for a flow path of the working medium between circumferentially adjacent airfoils.

A turbine blade or a vane unit may be manufactured, for example, by casting, which may be optionally followed by a post-machining process. Manufacturing variation and machining tolerances may lead to a step in the flow path at the interface of the mate faces of the platforms of two circumferentially adjacent airfoils, which may potentially affect engine performance.

### SUMMARY

Briefly, aspects of the present invention provide a chambered mate face for turbine blades and vanes. The embodiments described may minimize impact of manufacturing variation on engine performance.

According to a first aspect of the invention, an assembly of turbine blades or vanes is provided. The assembly comprises a first airfoil extending span-wise from a first platform and a second airfoil extending span-wise from a second platform. Each of the first and second airfoils comprises a respective outer wall formed of a pressure side and a suction side joined at a respective airfoil leading edge and at a respective airfoil trailing edge. Each of the first and second platforms extends from a respective platform leading edge to a respective platform trailing edge. The first platform comprises a first mate face proximal to the suction side of the first airfoil and the second platform comprises a second mate face proximal to the pressure side of the second airfoil. The first mate face faces the second mate face along a platform splitline extending between the platform leading and trailing edges of the first and second platforms. A flow path for a working medium is defined between the suction side of the first airfoil and the pressure side of the second airfoil. The first mate face is chamfered or filleted along an aft portion thereof. The chamfered or filleted portion of the first mate face lies in a region in the flow path where a mean velocity of the working medium is directed from the second platform to the first platform.

According to a second aspect of the invention, an article of manufacture is provided. The article of manufacture comprises at least one platform with one or more airfoils extending span-wise from the platform. Each of said one or more airfoils comprises an outer wall formed of a pressure side and a suction side joined at an airfoil leading edge and at an airfoil trailing edge. The platform extends from a platform leading edge to a platform trailing edge. The platform comprises a first mate face and a second mate face spaced along a pitch-wise direction. The first mate face is proximal to the suction side of one of the airfoils and the second mate face being proximal to the pressure side of the same airfoil or a different airfoil of said one or more airfoils. The first and second mate faces extend between the platform leading edge and the platform trailing edge. The first mate face is chamfered or filleted along an aft portion thereof. The chamfered or filleted portion of the first mate face extends from the platform trailing edge to a first intermediate point on the first mate face located between the platform leading edge and the platform trailing edge.

### BRIEF DESCRIPTION OF THE DRAWINGS

The invention is shown in more detail by help of figures. The figures show specific configurations and do not limit the scope of the invention.

FIG. 1 is a perspective view of a turbine blade usable in a gas turbine engine, where embodiments of the present invention may be incorporated;

FIG. 2 is a schematic sectional view, looking in an axial direction of the gas turbine engine, illustrating a forward facing step at a platform mat face caused by manufacturing variation;

FIG. 3 is a schematic radial top view of a pair of turbine blades or vanes illustrating an embodiment of the present invention;

FIG. 4 is a sectional view along the section IV-IV of FIG. 3;

FIG. 5 is a sectional view along the section V-V of FIG. 3; and

FIG. 6 is a sectional view, looking in a tangential direction, illustrating a wavy mate face having a chamfered or filleted portion according to an embodiment of the present invention.

### DETAILED DESCRIPTION

In the following detailed description of the preferred embodiment, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

In the description and drawings, the directional axes A, R and C respectively denote an axial direction, a radial direction and a circumferential direction of a gas turbine engine.

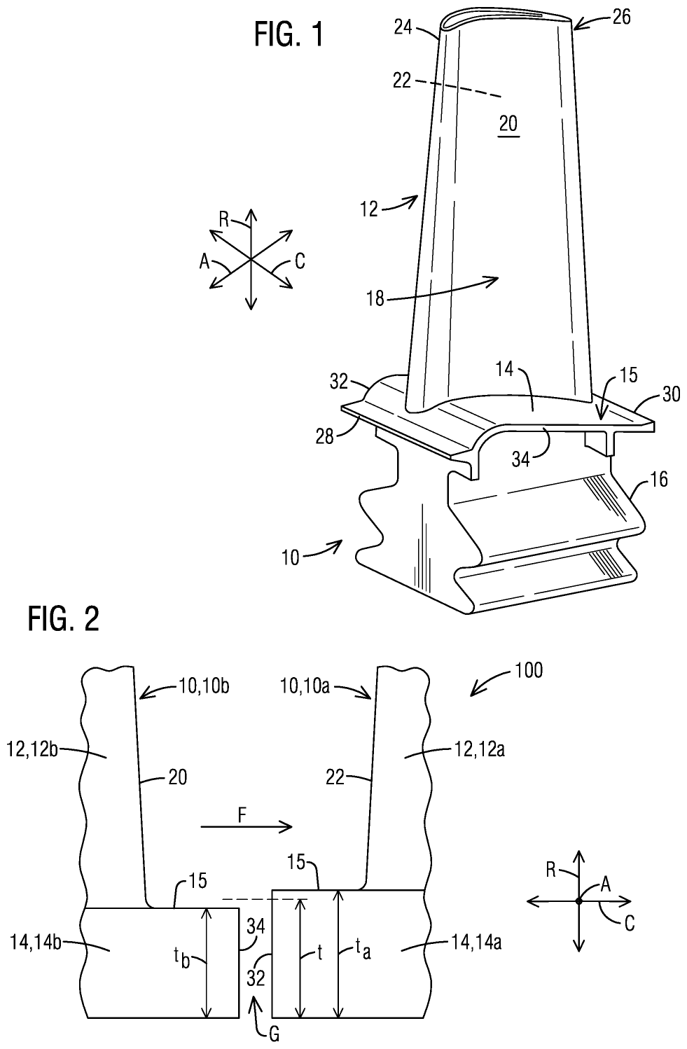

Referring now to FIG. 1, a turbine blade 10 is illustrated, wherein an embodiment of the present invention may be implemented. The turbine blade 10 comprises an airfoil 12 extending span-wise radially outward from a platform 14 in relation to a rotation axis A. The blade 10 further comprises a root portion 16 extending radially inward from the platform 14, and being configured to attach the blade 10 to a rotor disk (not shown). The airfoil 12 is formed of an outer wall 18 that delimits a generally hollow airfoil interior. The outer wall 18 includes a generally concave pressure side 20 and a generally convex suction side 22, which are joined at an airfoil leading edge 24 and at an airfoil trailing edge 26. The platform 14 comprises a radially outer surface 15 defining a radially inner boundary for a flow path of a working medium. The platform 14 thereby defines inner diameter endwall for the flow path. The platform 14 extends from a platform leading edge 28 to a platform trailing edge 30. The platform 14 also includes a first mate face 32 and a second mate face 34 spaced in a circumferential or pitch-wise direction C. Each of the mate faces 32 and 34 extends from the platform leading edge 28 to the platform trailing edge 30, with the first mate face 32 being proximal to the suction side 22 of the airfoil 12 and the second mate face 34 being proximal to the pressure side 20 of the airfoil 12. The mate faces 32 and 34 extend radially inward from the radially outer surface 15 of the platform 14 and interface with correspondingly opposite mate faces of circumferentially adjacent platforms to form an assembly of a row of turbine blades.

FIG. 2 schematically illustrates a portion of an assembly 100 of a row of turbine blades 10. The assembly 100 includes a first blade 10a having a first airfoil 12a extending from a first platform 14a, and a circumferentially adjacent second blade 10b having a second airfoil 12b extending from a second platform 14b. The first platform 14a has a first mate face 32 proximal to the suction side 22 of the first airfoil 12a. The second platform has a second mate face 34 proximal to the pressure side 20 of the second airfoil 12b. The first and second mate faces 32 and 34 face each other and are separated by a mate face gap G. In the shown example, the radial thickness tₐ of the first mate face 32 is greater than a design mate thickness t within a manufacturing tolerance, while, the radial thickness t_{b} of the second mate face 34 is lesser than the design mate thickness t within the manufacturing tolerance. Such a manufacturing variation may lead to a step in the flow path at the interface of the mate faces of the platforms of two circumferentially adjacent blades.

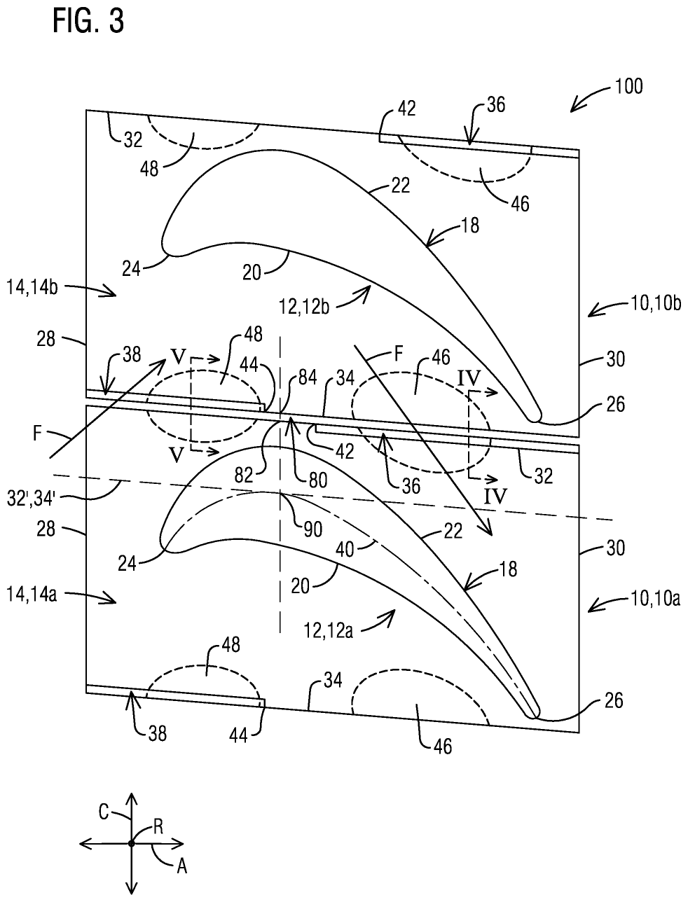

It has been observed that at least in some regions of the flow path between circumferentially adjacent blades, the mean velocity of the working medium is not purely axial but also has a pitch-wise component, i.e., directed from one platform to the circumferentially adjacent platform. In the example shown in FIG. 2, the mean velocity F of the working medium at the given section has a component which is directed from the second platform 14b to the first platform 14a, whereby a forward facing step is defined at the interface of the mate faces 32, 34. In general, a forward facing step may be said to formed when the mate face of the downstream platform (in relation to the direction of the mean velocity F) extends further into the flow path than the mate face of the upstream platform. The present inventors have recognized that especially a forward facing step, as shown in the example of FIG. 2, may cause aerodynamic losses and heat transfer problems due to flow separation and vortex formation at the platform mate faces. Embodiments of the present invention address at least the above described technical problem. In particular, the embodiments illustrated in FIG. 3-5 are directed to providing a chamfer and/or fillet along a portion of the mate face of one of the platforms, which is at a downstream position with respect to a circumferentially adjacent platform, in relation to the direction of the mean velocity of the working medium.

FIG. 3 illustrates portion of an assembly 100 of turbine blades 10 according to one embodiment of the present invention. Each blade 10 may include one or more airfoils 12 extending from a platform 14. In the example shown, a first airfoil 12a extends span-wise from a first platform 14a and a second airfoil 12b extends span-wise from a second platform 14b circumferentially adjacent to the first platform 14a. Each of the airfoils 12a, 12b comprises a respective outer wall 18 formed of a pressure side 20 and a suction side 22 joined at a respective airfoil leading edge 24 and at a respective airfoil trailing edge 26. Each of the first and second platforms 14a and 14b extends from a respective platform leading edge 28 to a respective platform trailing edge 30. Each of the platforms 14a and 14b further includes a pair of mate faces 32, 34 spaced in a circumferential or pitch-wise direction C. The pair of mate faces include a first mate face 32 proximal to the suction side 22 of the respective airfoil 12a or 12b, and a second mate face 34 proximal to the pressure side 20 of the respective airfoil 12a or 12b. The first mate face 32 of the first platform 14a is parallel to and faces the second mate face 34 of the second platform 14b along a platform splitline 80 extending between the platform leading and trailing edges 28, 30. A flow path for a working medium is defined between the suction side 22 of the first airfoil 12a and the pressure side 20 of the second airfoil 12b. The working medium flows in a generally axial direction from the platform leading edge 28 to the platform trailing edge 30, with the mean velocity varying in direction, as may be represented by the directional arrow F for the purpose of illustration.

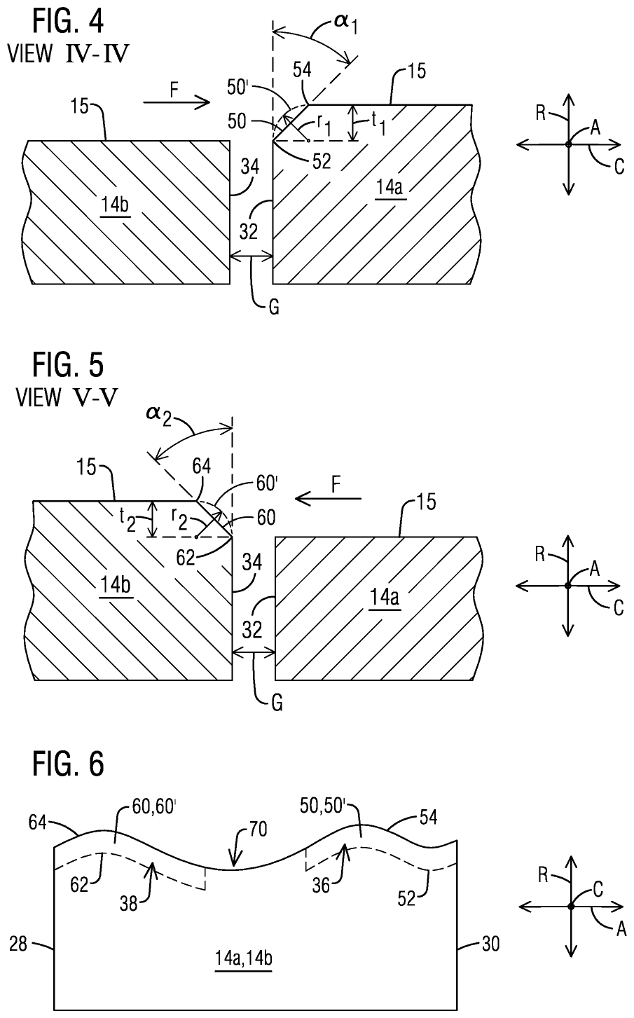

It has been observed that especially toward the aft end of the interface between the mate faces 32, 34, the mean velocity F is typically directed from the second platform 14b to the first platform 14a, with the flow Mach numbers being highest near the platform trailing edge 30. In the present embodiment, as shown in FIG. 4 with continued reference to FIG. 3, the first mate face 32 of the first platform 14a may be chamfered or filleted along an aft portion 36 thereof. In particular, the first mate face 32 may be chamfered or filleted to an extent such that the chamfered or filleted portion 36 lies in a region in the flow path where a mean velocity F of the working medium is directed from the second platform 14b to the first platform 14a. The second mate face 34 of the second platform 14b may be unchamfered and unfilleted along the extent thereof that lies directly opposite to the chamfered or filleted portion 36 of the first mate face 32 of the first platform 14a.

In particular, as shown in FIG. 3, the chamfered or filleted portion 36 of the first mate face 32 of the first platform 14a extends from the platform trailing edge 30 of the first platform 14a to a first intermediate point 42 on the first mate face 32 of the first platform 14a. The first intermediate point 42 is located between the platform leading edge 28 and the platform trailing edge 30 of the first platform 14a. The location of the first intermediate point 42 may be based, for example, on the determination of a point of inflection 82 on the first mate face 32. In an exemplary embodiment, such a point 82 may be determined by first determining a point 90 of tangency of a line 32′ parallel to the first mate face 32 to the mean camber line 40 of one of the airfoils, and projecting said point 90 on the first mate face 32 along the circumferential direction C to locate the point 82 on the first mate face 32, as shown in FIG. 3. The first intermediate point 42 on the first mate face 32 may lie at or aft of the point 82. In other embodiments, the extent of the chamfered or filleted portion 36 on the first mate face 32 may be determined by other means, including, for example, consideration of flow velocities during engine operation.

As shown in FIG. 4, in one embodiment, the chamfered portion of the first mate face 32 of the first platform 14a comprises a chamfered surface 50 extending radially from a first chamfer edge 52 to a second chamfer edge 54 at a chamfer angle α₁, which may be, for example and without limitation, 30 to 70 degrees, particularly about 40 to 50 degrees, with respect to the radial direction R. In an alternate embodiment, a similar technical effect may be realized by providing a fillet comprising a rounded surface 50′ (shown with dashed lines) with predefined radius r₁ extending between the edges 52, 54. The radial height t₁ of the chamfered or filleted surface 50, 50′ may dependent on the manufacturing process tolerances. In some embodiments, the chamfer height t₁ may range from 0.5% to 2% pitch distance of the blade/vane assembly. The chamfered or filleted surface 50, 50′ on the mate face 32 of the downstream platform 14a may reduce flow separation and vortex formation at the interface of the mate faces 32, 34, thereby minimizing aerodynamic losses and heat transfer issues that may be potentially caused by a forward facing step due to manufacturing variation. Referring to FIG. 3, the first mate face 32 of the second platform 14b may be provided with a similarly chamfered or filleted portion 36 at an aft portion, while the second mate face 34 of the first platform 14a may be provided with a corresponding unchamfered and unfilleted portion along an extent of the second mate face 34 that lies pitch-wise directly opposite to the chamfered or filleted portion 36 of the first mate face 32.

In a further embodiment, as shown in FIGS. 3 and 5, the second mate face 34 of the second platform 14b may be chamfered or filleted along a forward portion 38 thereof. This embodiment may be applicable to configurations in which the mean velocity F of the working medium has a pitch-wise component directed from the first platform 14a to the second platform 14b at a forward portion of the interface of the mate faces 32, 34. Accordingly, the second mate face 34 of the second platform 14b may be chamfered or filleted to an extent such that that the chamfered or filleted portion 38 lies in a region in the flow path where a mean velocity F of the working medium is directed from the first platform 14a to the second platform 14b. The first mate face 32 of the first platform 14a may be unchamfered and unfilleted along the extent thereof that lies directly opposite to the chamfered or filleted portion 38 of the second mate face 34 of the second platform 14b. The choice of having the chamfered (or filleted) portion 38 on the second mate face 34 may depend, for example, on a combination of blade geometry and engine flow parameters. For example, in some configurations, the mean velocity in the flow path may be substantially axial in the forward portion, whereby the need for chamfering or filleting a forward portion of the second mate face 34 may be obviated.

In the illustrated embodiment as shown in FIG. 3, the chamfered or filleted portion 38 of the second mate face 34 of the second platform 14b extends between the platform leading edge 28 of the second platform 14b and a second intermediate point 44 on the second mate face 38 of the second platform 14b. The second intermediate point 44 is located between the platform leading edge 28 and the platform trailing edge 30 of the second platform 14b. The chamfered or filleted portion 38 of the second mate face 34 may extend all the way up to the platform leading edge 28 of the second platform 14b or may stop short at a distance therefrom. The location of the second intermediate point 44 may be based, for example, on the determination of a point of inflection 84 on the second mate face 34. In an exemplary embodiment, such a point 84 may be determined by first determining a point 90 of tangency of a line 34′ parallel to the second mate face 34 to the mean camber line 40 of one of the airfoils 12, and projecting the point 90 on the second mate face 34 along the circumferential direction C to locate the point 84 on the second mate face 34, as shown in FIG. 3. The second intermediate point 44 on the second mate face 34 may lie at or forward of the point 84. In other embodiments, the extent of the chamfered or filleted portion 38 on the second mate face 34 may be determined by other means, including, for example, consideration of flow velocities during engine operation.

As shown in FIG. 5, in one embodiment, the chamfered portion of the second mate face 34 of the second platform 14b comprises a chamfered surface 60 extending radially from a first chamfer edge 62 to a second chamfer edge 64 at a chamfer angle α₂, which may be, for example and without limitation, 30 to 70 degrees, particularly about 40 to 50 degrees, with respect to the radial direction R. In an alternate embodiment, a similar technical effect may be realized by providing a fillet comprising a rounded surface 60′ (shown with dashed lines) with predefined radius r₂ extending between the edges 62, 64. The radial height t₂ of the chamfered or filleted surface 60, 60′ may dependent on the manufacturing process tolerances. In some embodiments, the chamfer height t₂ may range from 0.5% to 2% pitch distance of the blade/vane assembly. The chamfered or filleted surface 60, 60′ on the mate face 34 of the downstream platform 14b may reduce flow separation and vortex formation at the interface of the mate faces 32, 34, thereby minimizing aerodynamic losses and heat transfer issues that may be potentially caused by a forward facing step due to manufacturing variation. Referring to FIG. 3, the second mate face 34 of the first platform 14a may be provided with a similarly chamfered or filleted portion 38 at a forward portion, while the first mate face 32 of the second platform 14b may be provided with a corresponding unchamfered and unfilleted portion along an extent of the first mate face 32 that lies pitch-wise directly opposite to the chamfered or filleted portion 38 of the second mate face 34.

In a still further embodiment, the platforms 14a, 14b may define a contoured endwall facing the flow path, which is non-axisymmetric about the engine axis. In particular, a non-axisymmetric endwall may comprise one or more hills 48 and/or troughs 46 formed on the endwall, as shown by dashed lines in FIG. 3. A hill be may be defined as a contour wherein the endwall extends into the flow path in relation to a nominal radius of the endwall, whereas a trough may be defined as a contour wherein the endwall extends away from the flow path in relation to the nominal radius of the end wall. In one embodiment, at least one hill 48 and/or trough 46 may extend across the platform splitline 80, as shown in FIG. 3. In such a case, manufacturing variations caused by standard tolerances may lead to a steeper forward facing step than in a configuration without endwall contouring. The provision of a chamfer at the downstream platform is especially advantageous for contoured endwalls, to maximize the aerodynamic benefits provided by the contouring of the endwall. As shown in FIG. 6, on account of the non-axisymmetric endwall contouring, the first mate face 32 and/or the second mate face 34 may have a wavy contour 70, in a direction from the platform leading edge 28 to the platform trailing edge 30. In accordance with one embodiment, the chamfered or filleted portions 36, 38 respectively of the first and second mate faces 32, 34 may have a respective chamfer surface 50/50′, 60/60′ that follows said wavy contour 70, that is, the first chamfer/fillet edge 52, 62 is parallel to the respective second chamfer/fillet edge 54, 64, as shown in FIG. 6.

The above-described embodiments relate to inner diameter platforms of rotating turbine blades, wherein the first and second platforms 14a and 14b define an inner diameter endwall for the flow path of the working medium. In alternate embodiments, aspects of the present invention may be applied to inner or outer diameter platforms of stationary turbine vanes, wherein the platforms may define an inner or an outer diameter endwall for the flow path of the working medium.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. An assembly of turbine blades or vanes comprising:
a first airfoil extending span-wise from a first platform and a second airfoil extending span-wise from a second platform,
wherein each of the first and second airfoils comprises a respective outer wall formed of a pressure side and a suction side joined at a respective airfoil leading edge and at a respective airfoil trailing edge,
wherein each of the first and second platforms extends from a respective platform leading edge to a respective platform trailing edge,
wherein the first platform comprises a first mate face proximal to the suction side of the first airfoil and the second platform comprises a second mate face proximal to the pressure side of the second airfoil, the first mate face facing the second mate face along a platform splitline extending between the platform leading and trailing edges of the first and second platforms,
wherein a flow path for a working medium is defined between the suction side of the first airfoil and the pressure side of the second airfoil,
wherein the first mate face is chamfered or filleted along an aft portion thereof, the chamfered or filleted portion of the first mate face lying in a region in the flow path where a mean velocity of the working medium is directed from the second platform to the first platform.

2. The assembly according to claim 1, wherein the chamfered or filleted portion of the first mate face extends from the platform trailing edge of the first platform to a first intermediate point on the first mate face located between the platform leading edge and the platform trailing edge of the first platform.

3. The assembly according to claim 2, wherein the first intermediate point lies at or aft of a point of tangency of a line parallel to the first mate face to a mean camber line of the airfoils, as projected on the first mate face along a circumferential direction of the assembly of turbine blades or vanes.

4. The assembly according to claim 1, wherein second mate face is chamfered or filleted along a forward portion thereof, the chamfered or filleted portion of the second mate face lying in a region in the flow path where a mean velocity of the working medium is directed from the first platform to the second platform.

5. The assembly according to claim 4, wherein the chamfered or filleted portion of the second mate face extends between the platform leading edge of the second platform and a second intermediate point on the second mate face located between the platform leading edge and the platform trailing edge of the second platform.

6. The assembly according to claim 5, wherein the second intermediate point lies at or forward of a point of tangency of a line parallel to the second mate face to a mean camber line of the airfoils, as projected on the second mate face along a circumferential direction of the assembly of turbine blades or vanes.

7. The assembly according to claim 1, wherein the first and second platforms define a contoured endwall facing the flow path, the contoured endwall being non-axisymmetric about a central axis of the assembly of turbine blades or vanes.

8. The assembly according to claim 7, wherein the contoured endwall comprises at least one trough or hill that extends across the platform splitline.

9. The assembly according to claim 8, wherein the first and the second mate faces have a wavy contour in a direction from the respective platform leading edge to the respective platform trailing edge,
wherein the chamfered or filleted portion of the first mate face and/or the second mate face has a respective chamfer surface that follows said wavy contour.

10. The assembly according to claim 1, wherein the assembly is an assembly of turbine blades, wherein the first and second platforms define an inner diameter endwall for the flow path.

11. The assembly according to claim 1, wherein the assembly is an assembly of turbine vanes, wherein the first and second platforms define an inner diameter endwall for the flow path.

12. The assembly according to claim 1, wherein the assembly is an assembly of turbine vanes, wherein the first and second platforms define an outer diameter endwall for the flow path.

13. An article of manufacture comprising:
at least one platform;
one or more airfoils extending span-wise from the platform;
wherein each of said one or more airfoils comprises an outer wall formed of a pressure side and a suction side joined at an airfoil leading edge and at an airfoil trailing edge,
wherein the platform extends from a platform leading edge to a platform trailing edge,
wherein the platform comprises a first mate face and a second mate face spaced along a pitch-wise direction, the first mate face being proximal to the suction side of one of the airfoils and the second mate face being proximal to the pressure side of the same airfoil or a different airfoil of said one or more airfoils, the first and second mate faces extending between the platform leading edged and the platform trailing edge,
wherein the first mate face is chamfered or filleted along an aft portion thereof, the chamfered or filleted portion of the first mate face extending from the platform trailing edge to a first intermediate point on the first mate face located between the platform leading edge and the platform trailing edge.

14. The article of manufacture according to claim 13, wherein the first intermediate point lies at or aft of a point of tangency of a line parallel to the first mate face to a mean camber line of the airfoil, as projected on the first mate face along the pit-wise direction.

15. The article of manufacture according to claim 13, wherein second mate face is chamfered or filleted along a forward portion thereof,
wherein the chamfered or filleted portion of the second mate face extends partially or entirely between the platform leading edge and a second intermediate point on the second mate face located between the platform leading edge and the platform trailing edge of the second platform.

16. The article of manufacture according to claim 15, wherein the second intermediate point lies at or forward of a point of tangency of a line parallel to the second mate face to a mean camber line of the airfoil, as projected on the second mate face along the pitch-wise direction.

17. The article of manufacture according to claim 13, wherein the platform defines a contoured endwall.

18. The article of manufacture according to claim 17, wherein the first and the second mate faces have a wavy contour in a direction from the platform leading edge to the platform trailing edge,
wherein the chamfered or filleted portion of the first mate face and/or the second mate face has a chamfer surface that follows said wavy contour.
